(19) United States
(12) Patent Application Publication
(10) Pub. No.: US 2023/0244992 A1
(43) Pub. Date: Aug. 3, 2023

(54) INFORMATION PROCESSING APPARATUS, INFORMATION PROCESSING METHOD, NON-TRANSITORY COMPUTER READABLE MEDIUM

(71) Applicant: NEC Corporation, Minato-ku, Tokyo (JP)

(72) Inventors: Vivek Barsopia, Tokyo (JP); Yuta Ashida, Tokyo (JP)

(73) Assignee: NEC Corporation, Minato-ku, Tokyo (JP)

(21) Appl. No.: 18/012,408

(22) PCT Filed: Jun. 29, 2020
(86) PCT No.: PCT/JP2020/026312

§ 371 Date: Dec. 22, 2022

(51) Int. Cl. G06N 20/00; G06Q 20/40

(52) U.S. Cl. CPC G06N 20/00; G06Q 20/4016

(57) ABSTRACT

An information processing apparatus includes: a Soft Category Estimator configured to receive a plurality of Data Inputs which includes positive data and negative data and to estimate a soft category using predetermined parameters of a position, size and margin width of a rectangular pattern for classifying the Data Input as the positive data and the negative data; an Estimation Evaluator configured to compare the estimated soft category label with the true Data labels for the Data Input and output a feedback on the predetermined parameters; and a Parameter Modifier configured to modify the predetermined parameters to reduce a total loss to learn an optimal margined rectangular pattern for classifying the positive data and the negative data.

### TECHNICAL FIELD

The present disclosure relates generally to an information processing apparatus, information processing method, and non-transitory computer readable medium for appropriately classifying data input.

### BACKGROUND ART

In machine learning tasks such as fraudulent credit card transaction detection, a program is fed with transaction details such as a transaction amount, location, merchant ID, and time for determining if a transaction category is fraud(+ve) or non-fraud(−ve). This program may be referred to as a classifier. The transaction details may be referred to as data input/features. The category may also be referred to as a label.

We focus on bounded rectangular patterns obtained using a probabilistic concept, since the rules in the form of bounded rectangular patterns are easy to interpret and easy to match with any test input. NPL1 is a rectangular clustering method that can be used to identify fraud pattern(s).

### CITATION LIST

### Non Patent Literature

NPL 1: Junxiang Chen et. al. “Interpretable Clustering via Discriminative Rectangle Mixture Model”

### SUMMARY OF INVENTION

### Technical Problem

A classifier whose decision boundary should be a distance from +ve point that is equal to a distance from the −ve point, generally produces better generalization accuracy.

With reference to FIG. 8, a classifier with a general decision boundary is described below. FIG. 8 illustrates a pattern and matching method. One of the ways to interpret a pattern is to image the pattern as a subspace in feature space with some geometric shape. FIG. 8 shows a hard rectangle in which its center position is at the x1, x2 coordinates (10, 3) and the x1 lateral width and x2 vertical width=6, 4, the position 1 (7, 1), and the position u (13, 5). Any points with feature value 7<x1<13 and 1<x2<5 lies inside the rectangle (geometric shape), and thus are categorized as positive by the classifier. Accordingly, the classifier produces the rectangular pattern as shown in FIG. 8. For example, KNN (k-nearest neighbor) produces circular pattern, GMM (Gaussian Mixture Model) produces oval patterns, Decision tree classifier produces non-bounded rectangular patterns, and NPL1 produces bounded non-overlapping rectangular patterns.

With reference to FIGS. 13, 15, 17, a more appropriate decision boundary is described below. FIGS. 13, 15, 17 show three different rectangular patterns.

FIG. 11 shows the decision boundary which is a distance from positive and negative points. FIG. 15 shows the decision boundary which is close to negative points. FIG. 17 shows the decision boundary which is close to positive points. Among these figures, FIG. 11 shows a desired decision boundary since the decision boundary has maximum margin/optimal margin.

NPL1 is useful for finding the shape and location of a rectangle (described later in embodiment 1) that correctly classifies training data. However many positive points are very close to a decision boundary. As a result, the classifier with such a decision boundary cannot classify close points appropriately.

The present disclosure has been made in view of the aforementioned problem and aims to provide an information processing apparatus, an information processing method and a program for appropriately classifying data input and capable of obtaining optimal margin rectangle.

### Solution to Problem

An information processing apparatus according to a first exemplary aspect of the present disclosure includes:

a Soft Category Estimator configured to receive a plurality of Data Inputs which includes positive data and negative data and to estimate a soft category using predetermined parameters of a position, size and margin width of a rectangular pattern for classifying the Data Input as the positive data and the negative data;

an Estimation Evaluator configured to compare the estimated soft category label with the true Data labels for the Data Input and output a feedback on the predetermined parameters; and

a Parameter Modifier configured to modify the predetermined parameters to reduce a total loss to learn an optimal margined rectangular pattern for classifying the positive data and the negative data.

A classifier according a second exemplary aspect of the present disclosure includes: a hard category estimator configured to receive input data and estimate a category of the data point using a model leant by the information processing apparatus as described above.

An information processing method according to a third exemplary aspect of the present disclosure includes:

receiving a plurality of Data Inputs which includes positive data and negative data and estimating a soft category using predetermined parameters of a position, size and margin width of a rectangular pattern for classifying the Data Input as the positive data and the negative data;

comparing the estimated soft category label with the true Data labels for the Data Input and outputting a feedback on the predetermined parameters; and modifying the predetermined parameters to reduce a total loss to learn an optimal margined rectangular pattern for classifying the positive data and the negative data.

A non-transitory computer readable medium according to a fourth exemplary aspect of the present disclosure is a non-transitory computer readable medium storing a program for causing a computer to execute an information processing method, including:

receiving a plurality of Data Inputs which includes positive data and negative data and estimating a soft category using predetermined parameters of a position, size and margin width of a rectangular pattern for classifying the Data Input as the positive data and the negative data;

comparing the estimated soft category label with the true Data labels for the Data Input and outputting a feedback on the predetermined parameters; and modifying the predetermined parameters to reduce a total loss to learn an optimal margined rectangular pattern for classifying the positive data and the negative data.

### Advantageous Effects of Invention

According to the exemplary aspects of the present disclosure, it is possible to provide an information processing apparatus, method and program for appropriately classifying input data.

### BRIEF DESCRIPTION OF DRAWINGS

FIG. 1 is a block diagram illustrating exemplary functional modules of an information processing apparatus according to the first embodiment of the present disclosure.

FIG. 2 is a flowchart illustrating an operation example of an information processing method according to the first embodiment of the present disclosure.

FIG. 3 is a block diagram illustrating exemplary functional modules of a classifier according to the first embodiment of the present disclosure.

FIG. 4 is a diagram illustrating a configuration example of the total loss of the second embodiment of the present disclosure.

FIG. 5 is a block diagram illustrating an overview configuration of functional modules utilized by a classifier described in the NPL1.

FIG. 6 is a flowchart illustrating the training operation of the embodiments of the present disclosure.

FIG. 7 is a flowchart illustrating the testing operation of the embodiments of the present disclosure.

FIG. 8 is a diagram illustrating an example of a rectangular pattern and a matching method.

FIG. 9 is a diagram illustrating an example of the soft version/smooth version of a rectangular pattern shown in FIG. 8.

FIG. 10 is a diagram illustrating an example of the softer version/smoother version of the rectangular pattern shown in FIG. 8.

FIG. 11 is a block diagram illustrating exemplary functional modules of a classifier according to a third embodiment of the present disclosure.

FIG. 12 is a block diagram illustrating an exemplary configuration of parameters modifier according to the third embodiment of the present disclosure.

FIG. 13 is a diagram illustrating an example of a soft rectangle with different parameter settings with corresponding losses information.

FIG. 14 is a diagram illustrating an example of hard version of the soft rectangle shown in FIG. 13.

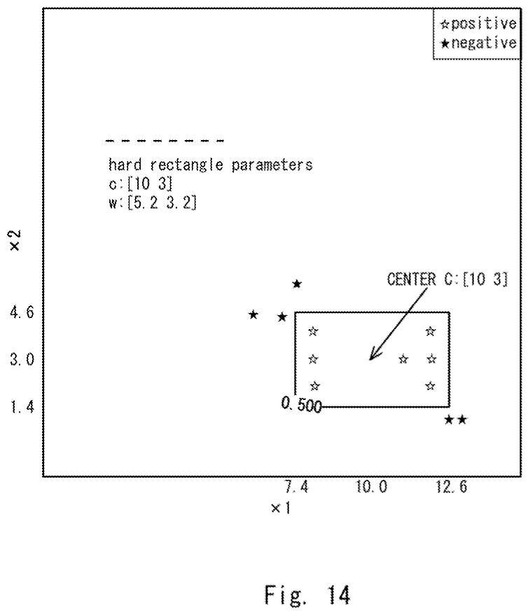

FIG. 15 is a diagram illustrating an example of a soft rectangle with different parameter settings with corresponding losses information.

FIG. 16 is a diagram illustrating an example of hard version of the soft rectangle shown in FIG. 15.

FIG. 17 is a diagram illustrating an example of a soft rectangle with different parameter settings with corresponding losses information.

FIG. 18 is a diagram illustrating an example of hard version of the soft rectangle shown in FIG. 17.

FIG. 19 is a diagram illustrating an example of multiple soft rectangles with corresponding losses and some information.

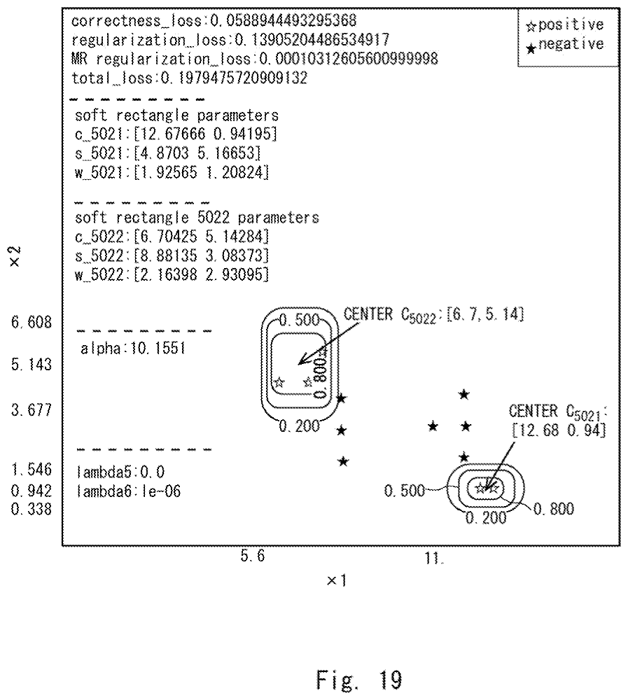

FIG. 20 is a diagram illustrating an example of multiple soft rectangles in FIG. 19 with corresponding losses and more information.

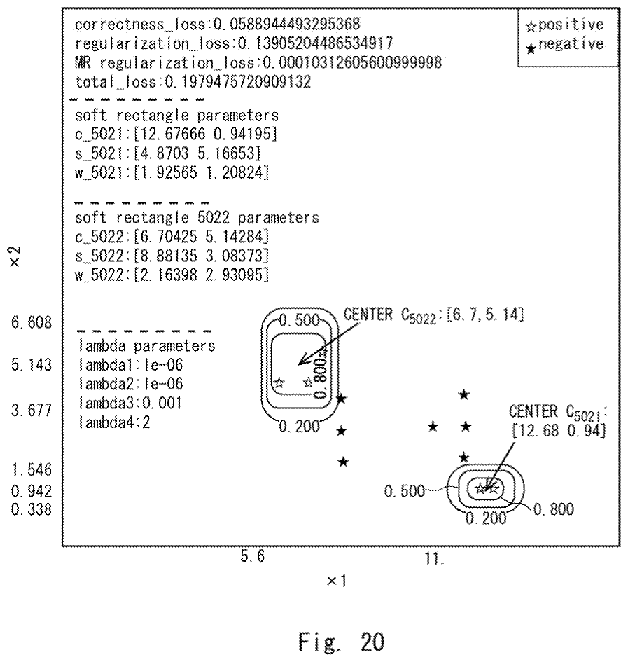

FIG. 21 is a diagram illustrating an example of hard version of multiple soft rectangles discussed in FIG. 19.

FIG. 22 is a diagram illustrating an example of multiple soft rectangles with losses and some information.

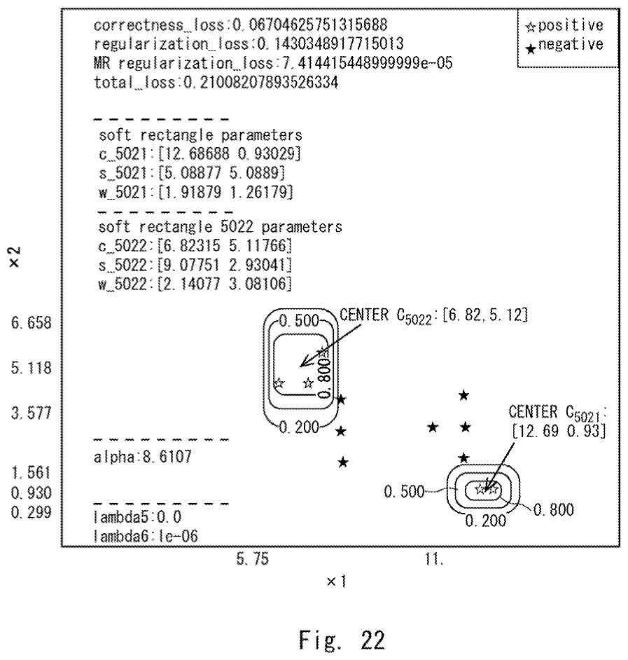

FIG. 23 is a diagram illustrating an example of multiple soft rectangles in FIG. 22 with losses and more information

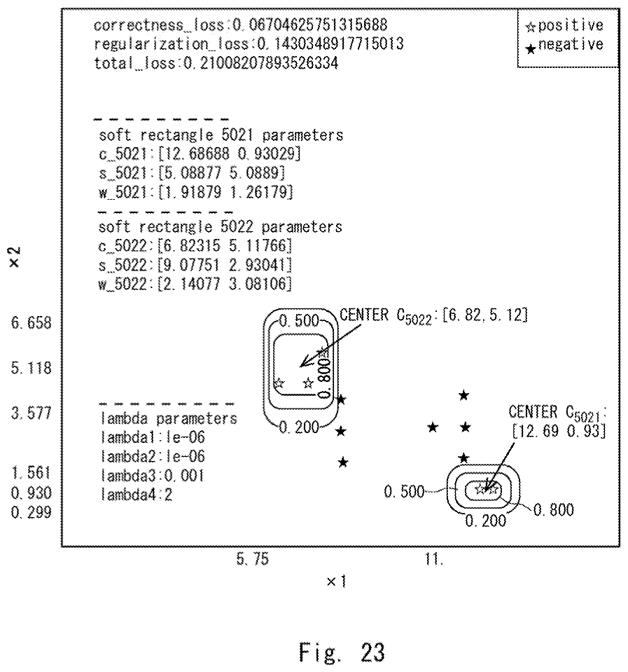

FIG. 24 is a diagram illustrating an example of hard version of the multiple soft rectangle shown in FIG. 22.

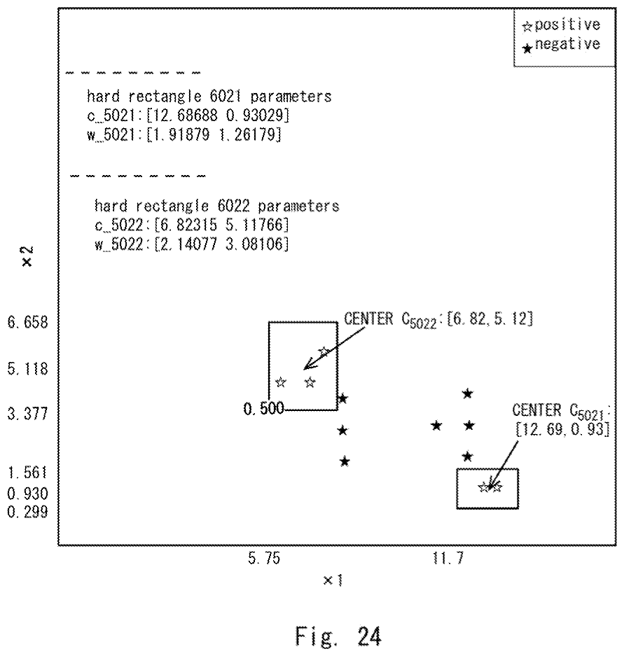

FIG. 25 is a block diagram illustrating a configuration example of the information processing apparatus.

### DESCRIPTION OF EMBODIMENTS

Hereinafter, specific embodiments to which the above-described example aspects of the present disclosure are applied will be described in detail with reference to the drawings. In the drawings, the same elements are denoted by the same reference signs, and repeated descriptions are omitted for clarity of the description.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

All the embodiments have a common process of training, testing, and matching patterns and a common concept of patterns which will be described later. The embodiments describe a training method/device to extract fraud transaction rectangular patterns and a testing device to predict the transaction using extracted patterns.

In all the embodiments, during the training process, a training module learns patterns of fraudulent transactions using fraud transaction data or a combination of fraud and non-fraud transaction data. During the testing process, testing data input is compared with extracted fraud patterns, and categorized as fraud if the testing data matches any learnt pattern. All the embodiments solve narrow and wide margin problems by proposing a training module and a testing module for binary categorization of data.

For the first embodiment, the training module extracts a single optimal margined rectangular pattern during a training phase. For the second embodiment, the training module extracts multiple non-overlapping optimal margined rectangular pattern during the training phase. During the testing phase, the data input is matched with all rectangular patterns and then categorized positive if any pattern matches the data input.

### First Embodiment

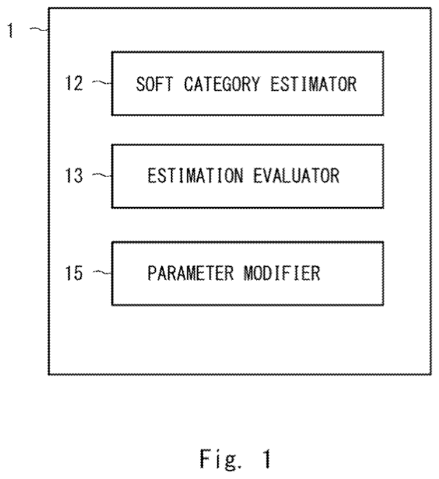

FIG. 1 is a block diagram illustrating exemplary functional modules of an information processing apparatus according to the first embodiment of the present disclosure.

An information processing apparatus 1 includes a soft category estimator 12, an estimation evaluator 13, and a parameter modifier 15. The Soft Category Estimator 12 is configured to receive a plurality of Data Inputs which includes positive data and negative data and to estimate a soft category using predetermined parameters of a position, size and margin width of a rectangular pattern for classifying the Data Input as the positive data and the negative data. The Estimation Evaluator 13 is configured to compare the estimated soft category label with the true Data labels for the Data Input and output a feedback on the predetermined parameters. The Parameter Modifier 15 is configured to modify the predetermined parameters to reduce a total loss to learn optimal margined rectangular patterns for classifying the positive data and the negative data.

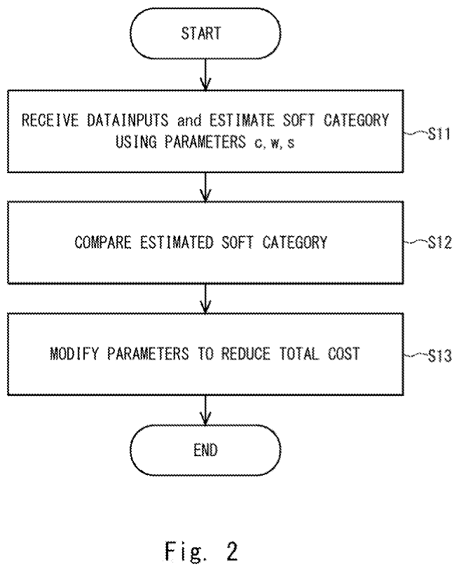

FIG. 2 is a flowchart illustrating an operation example of the first embodiment of the present disclosure.

The information processing apparatus 1 receives a plurality of Data Inputs which includes positive data and negative data and estimate a soft category using predetermined parameters of a position, size and margin width of a rectangular pattern for classifying the Data Input as the positive data and the negative data (S11). The information processing apparatus 1 compares the estimated soft category label with the true Data labels for the Data Input and outputs a feedback on the predetermined parameters (S12). The information processing apparatus 1 modifies the predetermined parameters to reduce a total loss to learn optimal margined rectangular patterns for classifying the positive data and the negative data (S13).

The first embodiment of the disclosure can modify the predetermined parameters and learn optimal margined rectangular patterns for appropriately classifying the positive data and the negative data.

### Second Embodiment

To better understand the method to solve the problems of related art described in NPL1, the related art needs to be examined in detail.

### Technical Explanation of NPL1

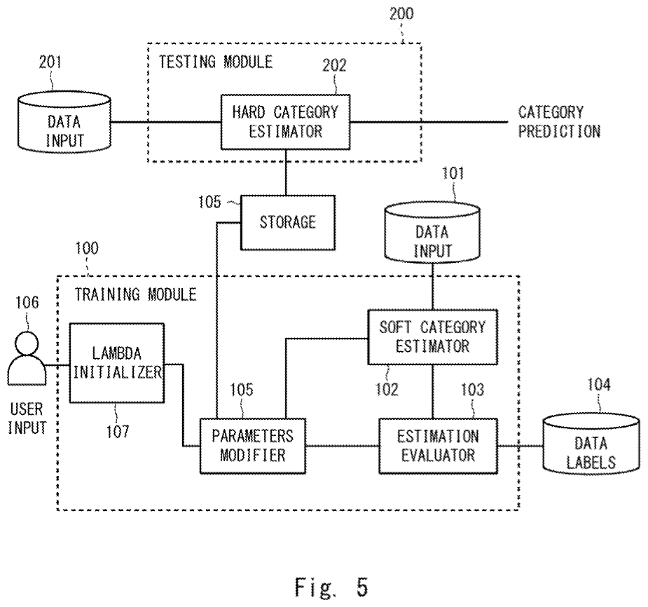

FIG. 5 is a block diagram illustrating an overview configuration of functional modules utilized by a classifier described in the NPL1. The classifier configuration includes two modules, training module 100 and testing module 200. These functional modules may be realized by an optional combination of the hardware units and the software programs. The classifier may be realized by a physically combined device, or two or more physically separated devices are connected by a wired means or a wireless means, and is realized by a plurality of these devices.

The Training module 100 receives data Input 101 including examples of fraud transactions and extracts one or more rectangular patterns. The training module 100 then stores the rectangular patterns in storage 105. The training module 100 also receives user input 106. The user input 106 is used to initialize lambdas and scale by lambda initializer 107. The lambda initializer 107 sets three parameters, namely lambda1 1071, lambda2 1072, scale 1073. These parameters affect the extracted pattern structure. Typically lower values of lambda1 1071 and lambda2 1072 result in rectangular patterns which are increased in size. We will discuss about the scale parameter 1073 in the next section. Data Labels 104 is the storage for true labels/categories of training data. Data Labels 104 consist of category information for each data point in Data Input 101.

<NPL 1 for Single Rectangular Pattern>

NPL 1 categorizes a data point p100 as positive (fraud) if the data point lies inside a rectangle, that is, the rectangle covers the data point p100. As shown in FIG. 5, hard category estimator 202 in testing module 200 conducts the inside or outside test about whether an input data point is inside or outside the rectangle. Hard category estimator 207 is implemented with ƒ(·;c,w).

$$f ( x ; c , w ) = {{\prod }^{m}}_{i = 1} step ( ( {u}_{i} - {x}_{i} ) ) * step ( ( {x}_{i} - {l}_{i} ) ) \\ step ( a ) = 1 if a > 0 else 0$$

A rectangle in m-dimension is algebraically described with two parameters c & w which are m-dimensional vectors (where m is the number of features). The center position parameter c denotes the center position (coordinates) of the rectangle. The width parameter w denotes the lateral and vertical sizes of the rectangle. A rectangle can also be described using two parameters l,u. l=c−w/2. u=c+w/2. l is the start coordinate and u is the end coordinate.

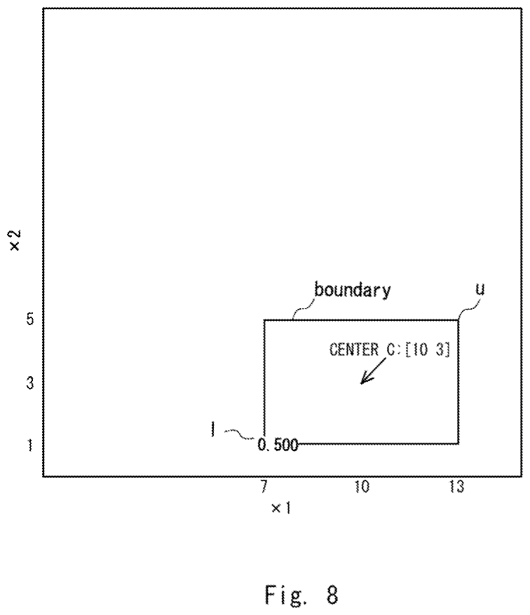

For m=2, FIG. 8 illustrates a rectangle in which its center position c=(10,3) and the x1 and x2 widths w=(6,4). Also, the start and end coordinates of the rectangle can be described as l=(7, 1) & u=(13, 5). The rectangle starts from 7 unit in dimension x1 and ends at 13 unit. In x2, the rectangle starts at 1 unit and ends at 5 unit. Any point with x1 in range [7, 13] and x2 in range [1, 5] will be categorized as positive.

The classifier described in NPL1, during training time, generates one or more rectangles to cover the positive training data. Learnt rectangular pattern(s) are used during testing time to categorize data point as positive or negative.

However, during training time, NPL1 approximates estimation by hard category estimator 202, with Soft Category Estimator 102. Hard Category Estimator 202 uses step function. The Soft Category Estimator 102 is obtained by replacing the step function with a sigmoid function. The sigmoid function is differentiable approximation of step function. The step function may be also referred to as hard step function.

g(·;c,w,s) is mathematical implementation of Soft Category Estimator 102.

$$g ( x ; c , w , s ) = {{\prod }^{m}}_{i = 1} σ ( {s}_{i} ( {u}_{i} - {x}_{i} ) ) * σ ( {s}_{i} ( {x}_{i} - {l}_{i} ) ) \\ Where u , l = ( c + \frac{w}{2} ) , ( c - \frac{w}{2} )$$

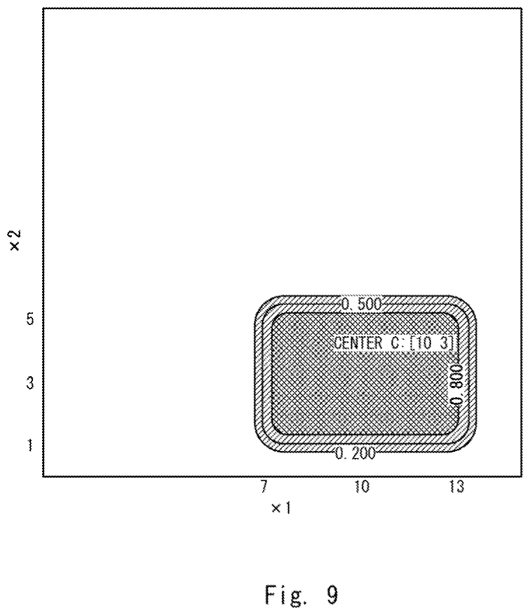

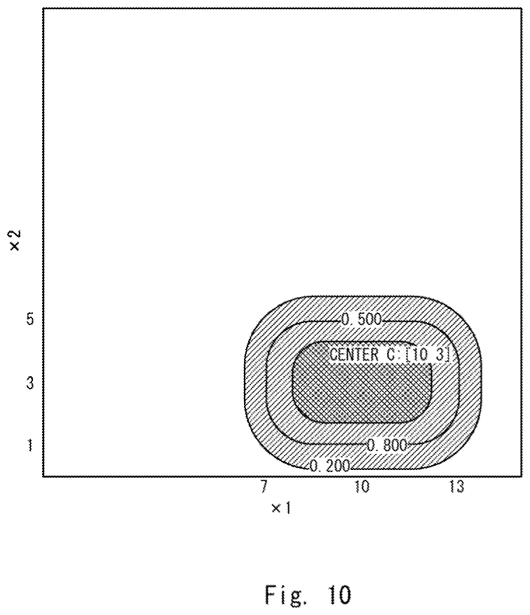

FIG. 8 illustrates the exemplary decision regions generated by hard category estimator 202. FIGS. 9, 10 illustrate the exemplary decision regions generated by the soft Category Estimator 102. FIGS. 8, 9, 10 are for same setting of c,w, but FIGS. 9, 10 are for the different scales s=6, 6 and s=2, 2 respectively.

g(x) ^{≈}ƒ(x)^{≈}l for points in the core, g(x) ^{≈}ƒ(x)^{≈}0 for outside points. Here, the core is a term for soft rectangle (which is depicted by cross-hatched lines in FIGS. 8, 9). The core refers to an area of high confidence/high certainty. This core exists near the center of the rectangle (away and inwards from boundary). Boundary refers to region of uncertainty. The Soft Category Estimator 102 may certainly indicate that any points in the core interior are positive and any points far away from the rectangle are negative. On the other hand, g(x) ^{≈}0.5 for points near the boundaries (which is depicted by the hatched line area). That is, the Soft Category Estimator 102 may indicate uncertainly as to whether points on the rectangle boundaries are positive or negative, and thus produces category 0.5 (neither positive nor negative) as shown in FIG. 9.

In summary, the Soft Category Estimator 102 estimates an approximation of the hard category estimator 202. Soft Category estimator 102 has predetermined parameters c, w, s. It makes sense to obtain the correct value of c,w to cover the training data. However, s is also important for generating margin so that unseen positive test input data also gets covered.

w is a parameter for adjusting the size of a rectangle. w is adjusted so that positive training points are covered by the rectangle with minimum volume. However, w only covers positive points available during training time, due to this characteristic. NPL1 (at higher value of s) extracts rectangular patterns such that positive points lie inside the boundary but very close to the boundary since the margin is narrow. This is a problem in that some test positive points may go outside the rectangle. This kind of incorrect categorization caused by a narrow margin may be referred to as a narrow margin problem.

To solve the narrow margin problem, one can increase the wideness of the margin by selecting a lower value of s to ensure that positive points are well inside the core of the rectangle. This makes the rectangle larger in order to obtain a high ( [symbol] E) soft label for positive points. At lower s 1073, the rectangle becomes too wide so that some negative points will end up being close to or inside the boundary. This will cause incorrect categorization of negative test input data. This problem may be referred to as a wide margin problem.

An inappropriate value of s set by user input 106 can either cause the wide margin or narrow margin problem. It is desired that the rectangles be optimally margined. That is, neither positive points nor negative points should lie near the decision boundary. An optimal margin is determined by selecting the correct value of s.

It is difficult for a user to manually select the correct value of s, and thus it is desired that it be possible for s to be automatically set (like the other parameter c & w).

The training module 100 uses only positive data during training. The training module 100 does not know if the rectangle is smooth enough so that negative points (not being used during training) will also get covered by the rectangle. It is impossible for the training module 100 to determine an optimal margin by only using positive data.

If the margin is too wide, non-fraud training and testing samples will be incorrectly categorized. Similarly, if the margin is too narrow, some test input data belonging to the fraud category will be incorrectly categorized (since such test input data will lie outside the boundary).

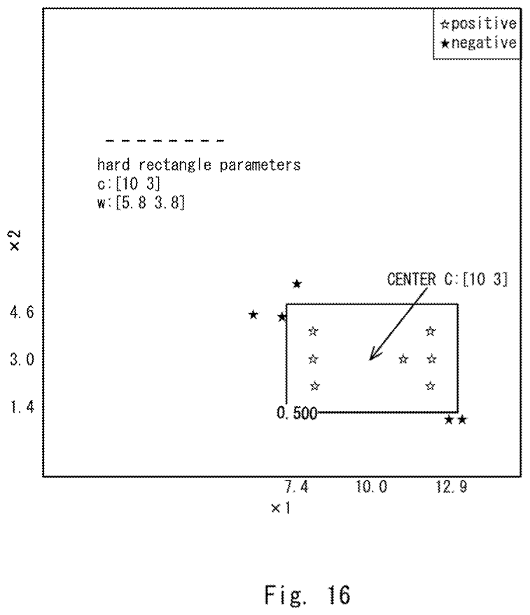

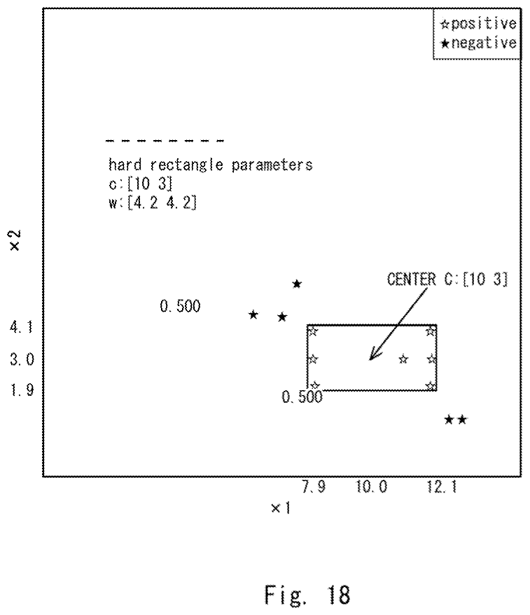

Identifying a margin correctly is very important to achieve higher prediction performance/accuracy during test time. s 1073 parameter adjusts the margin, but it is a part of user input 106. Incorrect setting of s 1073 could produce patterns which are either narrow margined (FIG. 18) or wide margined (FIG. 16).

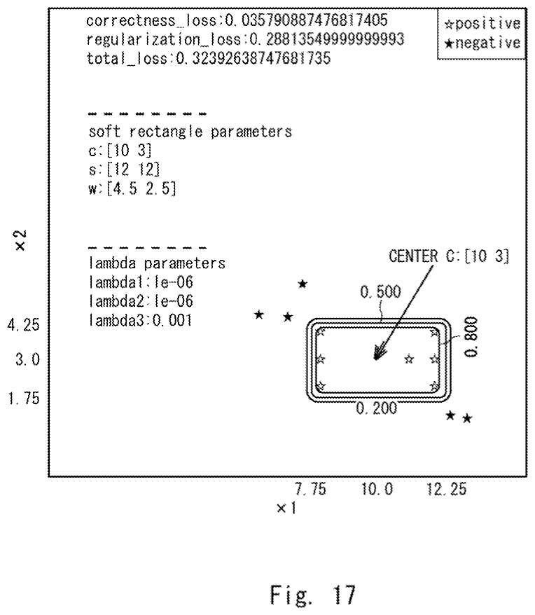

In FIG. 18, positive points are lie near the boundary of hard rectangle obtained from soft rectangle in FIG. 17 with s=12, 12. In FIG. 18, positive points lie near the boundary of hard rectangle obtained from soft rectangle (FIG. 17) with s=12,12. In FIG. 16, positive points lie inside and away from boundary of hard rectangle, but negative points outside rectangle lie near the boundary.

Even after using a positive data, adjusting a margin after post processing is not the best way to solve the narrow margin problem in extracting multiple rectangular patterns, since the obtained rectangular boundaries in post-processing may not be optimal margined.

We now explain the modifications to the NPL1 in order to solve the narrow margin and wide margin problems.

<Training and Testing Device of Present Disclosure>

The second embodiment of the present disclosure is capable of extracting a single optimal margin rectangular rule to categorize the data.

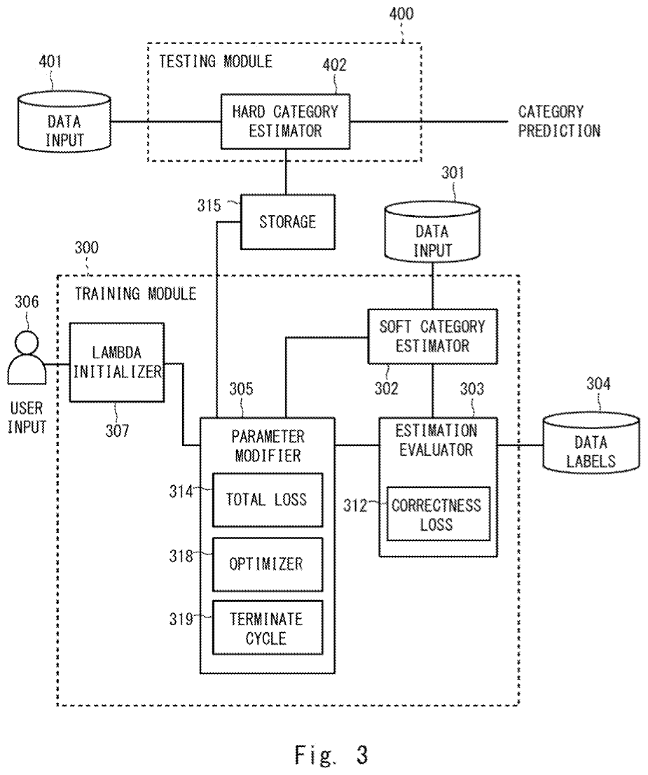

FIG. 3 is a block diagram illustrating exemplary functional modules of a classifier according to the second embodiment of the present disclosure. These functional modules may be realized by an optional combination of the hardware units and the software programs. The classifier may be realized by a physically combined device, or two or more physically separated devices are connected by a wired means or a wireless means, and is realized by a plurality of these devices.

Training module 300 includes Soft Category Estimator 302, Estimation evaluator 303, and parameters modifier 305, as shown in FIG. 3. Training module 300 conducts a process of extracting patterns of fraudulent transactions from training datasets (including examples for fraudulent and non-fraudulent transactions). The process of extracting patterns may be referred to as training.

The training module 300 receives Data Input 301 and Data labels 304 as input to produce rectangular patterns. The produced rectangular patterns are then stored in Storage 315. The training module 300 also receives user input 306. The user input 306 is used to initialize lambdas by Lambda Initializer 307. The lambda Initializer 307 includes parameters lambda1 3071, lambda2 3072, and lambda3 3073 to guide the Training module 300. Higher values of the lambda1 3071 make rectangle be centered near an origin. Higher values of lambda2 3072 make a rectangle smaller. We will further discuss lambda3 3073 and user input 306 while explaining the Parameter Modifier 305.

In testing device 400, Hard Category Estimator 402 receives input data from data input 401 to estimate the category of the input data points.

### <Configuration of Training Device 300>

In the following section, we refer to s₃₀₂ as s. Similarly, we refer to c₃₀₂ as c and w₃₀₂ as w. We also refer to lambda1 3071, lambda2 3072, lambda3 3073 as lambda1, lambda2, lambda3 in the following section.

The data input 301 is the storage for the training data. The data input 301 contains the total n examples which include positive data points and negative data points. In further section, i^{th} data point will be referred to as x⁽ⁱ⁾.

In credit card fraud, data point x⁽¹⁰¹⁾ describes a transaction using m dimensional vector. For example, [user ID, time, location, amount, merchant ID] is a 5(m=5) dimensional vector describing a user, time of transaction, the location where user's card is swiped, the transfer amount and merchant ID.

The data labels 304 is the storage for true labels/categories of training data. The data labels 304 contains the (known) categories for the training data stored in the Data Input 301. The Categories may also be referred as true labels. In a later section, a true label for i^{th} data point will be referred to as yᵢ.

The data points with a positive category are true labeled as 1 while the data points with a negative category are true labeled as 0. In the example of credit card fraud, for point x⁽ⁱ⁾, the true label=1 indicates a fraud transaction. Similarly, the true label=0 indicates a non-fraud transaction.

Soft Category Estimator 302 receives data point x⁽¹⁰¹⁾ as input and generates a corresponding soft label ŷ₁₀₁ (fraud/non-fraud). The soft label may be also referred to as soft category, when used in mathematical discussions.

The soft label ŷ₁₀₁ for data point x⁽¹⁰¹⁾ is a number between [0,1] indicating the probability of true label=1 for the data point y₁₀₁. For example, estimated soft label ŷ₁₀₁=0.9 means 90% chance x⁽¹⁰¹⁾ is positive (y₁₀₁=1), and 10% chance x⁽¹⁰¹⁾ is negative (label is 0).

The Soft Category Estimator 302 should estimate a highly confident and correct soft category More precisely, Soft Category Estimator 302 may generate soft label ŷ1 for point x^{(j)} close to 1.0 (^{≈}100% chance that category is positive) if true label yⱼ=1. Similarly, the Soft Category Estimator 302 may predict soft label ŷⱼ close to 0 (i.e. ^{≈}0% chance that category is positive), if true label yⱼ=0.

Soft Category Estimator 302 is implemented in function g(·;c,w,s).

$$g ( x ; c , w , s ) = {{\prod }^{m}}_{i = 1} σ ( {s}_{i} ( {u}_{i} - {x}_{i} ) ) * σ ( {s}_{i} ( {x}_{i} - {l}_{i} ) ) \\ Where u = ( c + \frac{w}{2} ) , l = ( c - \frac{w}{2} )$$

and x is a data point.

Soft Category Estimator 302 includes soft-rectangle parameters c,w,s which describe the position, size and margin width of the rectangular pattern. Soft Category Estimator 302 may use predetermined soft-rectangle parameters c,w,s. To determine correct values of c,w,s, the Soft Category Estimator 302 should produce highly confident and correct category estimates.

We will discuss a way of determining values of c,w,s so that Soft Category Estimator 302 can produce highly confident and correct category estimates (on training dataset).

Estimation Evaluator 303 compares the estimated soft labels with the true labels and then outputs a real number which gives feedback on the predetermined values of c,w,s.

Correctness loss 312 is a mathematical implementation of the Estimation evaluator 303. Higher value of Correctness loss 312 (or any other classification loss) on labelled training data (input training data and corresponding labels) means the estimated soft labels {ŷ₁, ŷ₂, . . . , ŷₙ} are not similar to true labels {y₁, y₂, . . . , yₙ}. Lower value of correctness loss 312 means the estimated labels are similar to true labels.

$$correctness\_loss 312 = \frac{1}{n} * {\sum }_{j = 1}^{n} \vert g ( {x}^{( j )} ; c , w , s ) - {y}_{j} \vert$$

Where D={(x⁽¹⁾,y₁), . . . , (x⁽ⁿ⁾,yₙ)} is the training dataset with n data points. Data feature of i^{th} sample point denoted by x⁽ⁱ⁾ are obtained from Data Input 301. The label of i^{th} sample point denoted as yᵢ indicates a corresponding label obtained from Data labels 304.

The Estimation evaluator 303 penalizes (i.e. generates higher loss) the rectangle if the rectangle covers any negative point. The Estimation evaluator 103 in the FIG. 5 of NPL1 does not penalize negative training data.

The Parameter modifier 305 includes three components: total loss 314, optimizer 318, and terminate cycle 319, as shown in FIG. 3.

1) Total loss 314 is a loss function that evaluates the quality of predictions and model structure.
2) Optimizer 318 that modifies the soft-rectangle parameters c,w,s to reduce the total loss 314.
3) Terminate cycle 319, which saves/updates the learnt pattern to the Storage 315 and terminates the training module 300 if a better pattern cannot be found.

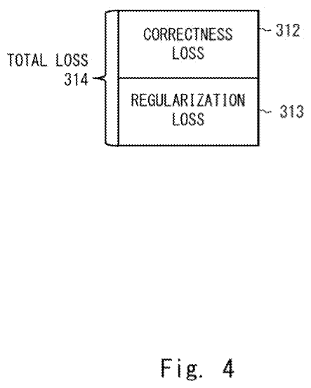

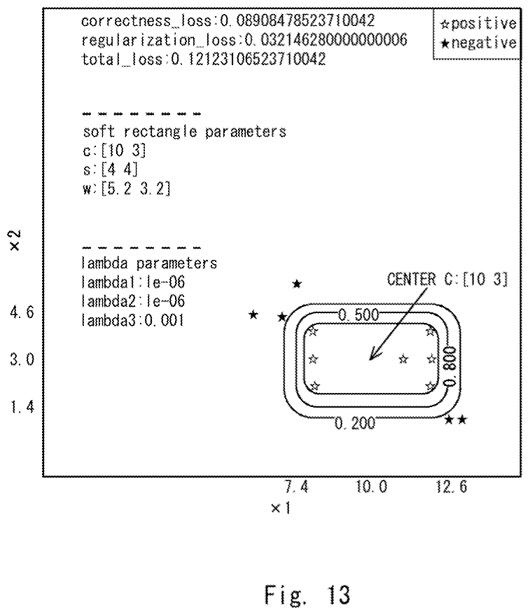

Given two rectangle settings in FIG. 13, 17 that produce similar predictions {ŷ₁, ŷ₂, . . . , ŷₙ}, and therefore have the similar correctness loss 312, in this case, some embodiments of the present disclosure will select the smoother rectangle that covers positive points in the core. Priority of selecting smooth rectangle is implemented with the Regularization Loss 313 in Total loss 314, as shown in FIG. 4.

The Regularization Loss 313 (any convex regularizer) receives rectangle parameters c,w,s as input and outputs a real number. Lower value of Regularization Loss 313 means rectangle is wide margined, small in size and closer to the origin.

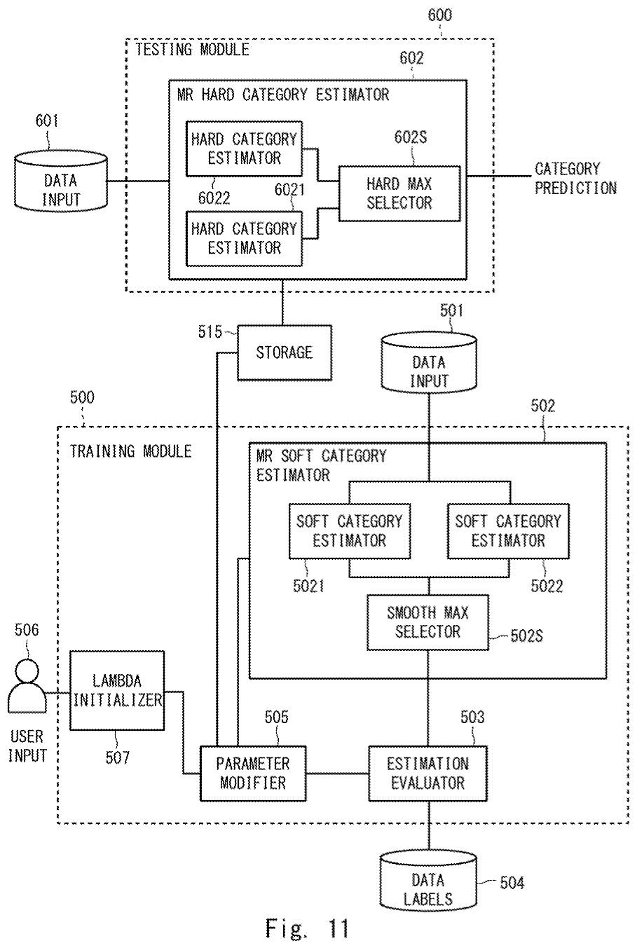

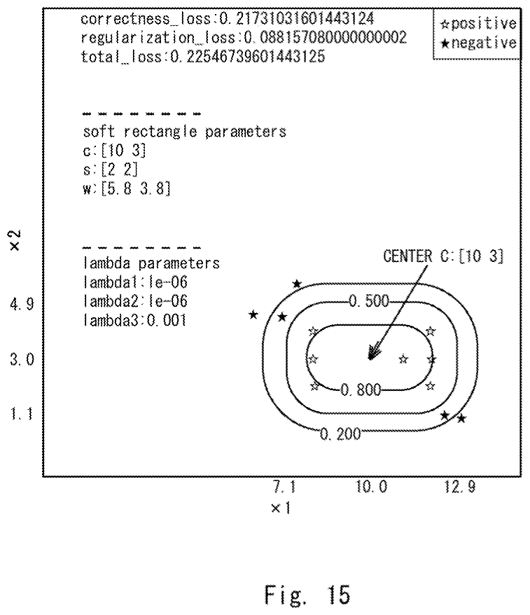

Refer to FIGS. 13, 15, 17 for examples of soft rectangles with different parameter settings. The rectangle in FIG. 11 has the lowest total loss. Regularization Loss 313 is given as:

Regularization_Loss313=lambda1*∥c∥²+lambda2*∥w∥²+lambda3*∥s∥²

“lambda3*∥s∥²∥” is a new component which is missing in related art (NPL1).

“lambda3*∥s∥²∥” may produce lower loss for a rectangle with small s(wide margin) in comparison to a rectangle with large s(narrow margin).

The Total loss 314 is a sum of correctness loss 312 and Regularization Loss 313, as shown in FIG. 4. Regularization Loss 313 creates rectangle with small size and softer boundaries while the correctness loss 312 gets the estimated soft labels to be close to either 0 or 1 (which happens only when none of the training points lies near the boundary of the soft rectangle).

Thus, the total loss 314 is a minimum value when a smooth rectangle (soft rectangle) is wide enough so that positive points are in the core and not too wide so that negative points come close to the rectangle boundary.

The Optimizer 318 may determine what the reason for incorrect estimation is and then tune the soft-rectangle parameters such that the Soft Category Estimator 302 with updated soft-rectangle parameters c, w, s has a lower total loss 314, in comparison to that of the previous parameter setting.

The Optimizer 318 in the Parameters modifier 305 is implemented using an off the shelf gradient or a line search-based algorithm (such as Adam, SGD, Wofle, Armijio, etc.) to obtain parameter settings to minimize any differentiable function.

The present embodiment minimizes the total loss 314 which is rewritten mathematically as L(c,w,s;D).

$$L ( c , w , s ; D ) = \frac{1}{n} * {\sum }_{j = 1}^{n} \vert g ( {x}^{( j )} ; c , w , s ) - {y}_{j} \vert + lambda 1 * {‖ c ‖}^{2} + lambda 2 * {‖ w ‖}^{2} + lambda 3 * {‖ s ‖}^{2}$$

The Optimizer 318 determines the value c,w,s using gradient descent such that the L(c,w,s;D) is minimized.

s by default takes low values (in order to lower the Regularization Loss 313), however s will take large values (make a margin narrow) if the correctness loss 312 is increased because of the wide margin problem as mentioned above.

Accordingly, the Optimizer 318 according to the present embodiment has a loss function that selects rectangle with an optimal margin, by determining appropriate values parameter c, w and s.

The iterative process of re-tuning the parameter is stopped by the Terminate Cycle 319. The Terminate Cycle 319 decides to stop the training procedure based on some criteria. Examples of the criteria include the case where there is no possibility to tune the parameter anymore (when minimal is achieved) or the case where the maximum number of updates is reached or time is limited. When the Terminate Cycle 319 terminates the iterative process of re-tuning the parameter, the, Parameters modifier 305 exports the soft-rectangle parameters c, w, s to Storage 315. The Storage 315 may be inside the training module 300 or the testing module 400, or may be outside the training module 300 or the testing module 400. The Terminate Cycle also may be referred to as a terminator.

The gradient descent based optimizer 318 continuously makes minor updates to c,w,s in order to decrease the total loss 314. A termination condition like maximum number of updates may guarantee the Training Module 300 will stop.

### <Testing Module 400>

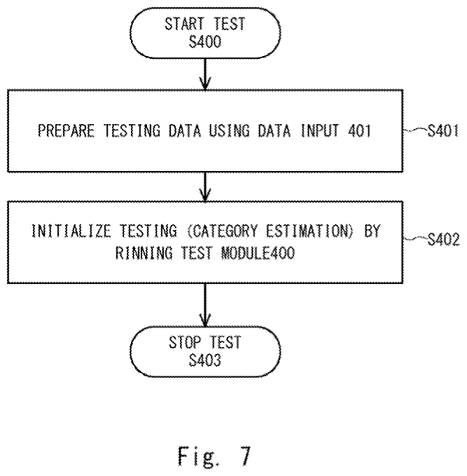

Testing Module 400 receives Data input 401, and hard category estimator 402 estimates the hard category. FIG. 8 is a diagram illustrating one example of an extracted pattern. FIG. 7 illustrates the process of matching the test input data with the extracted pattern. Testing Module 400 perform testing to categorize the test input data as a transaction fraud/non-fraud.

The Data Input 401 is the storage for the testing data. The testing data contains the set of test data points whose labels/categories are unknown.

The Hard Category Estimator 402 estimates the category of the test input data. The Hard Category Estimator 402 uses the Data Input 401 and predicts/determines/estimates the hard category of each test data point. Function ƒ(·,c,w) is the implementation of the Hard Category Estimator 402. c,w is extracted from the Storage 315.

$$f ( x ; c , w ) = {{\prod }^{m}}_{i = 1} step ( ( {u}_{i} - {x}_{i} ) ) * step ( ( {x}_{i} - {l}_{i} ) ) \\ step ( a ) = 1 if a > 0 else 0 \\ Where u = ( c + \frac{w}{2} ) , l = ( c - \frac{w}{2} )$$

Where uᵢ,lᵢ are i^{th} dimension of u,l.

### <<Operation of Second Embodiment>>

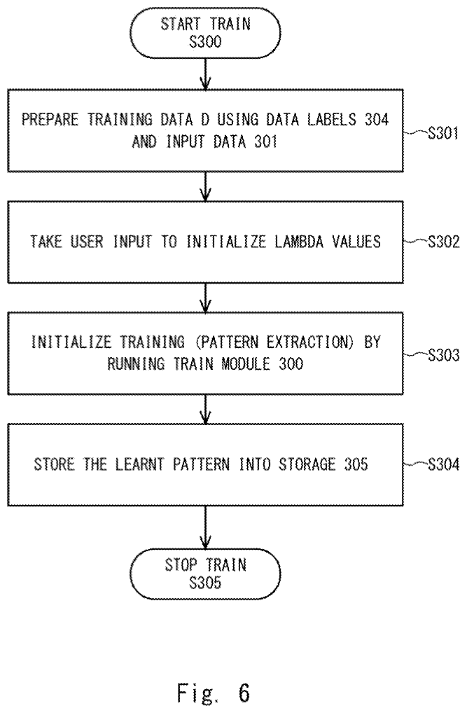

The training and testing operations of the second embodiment are explained with reference to FIG. 6 and FIG. 7 respectively. The operations in the information processing methods described here may be implemented by running one or more functional modules in information processing apparatus such as general purpose processors or application specific chips.

### <Operation of Model Training Module 300>

The Training module 300 starts the Training process as following. In step S301, the Soft category estimator 302 receives input data from Data Input 301 which consists of positive and negative train samples. Optionally, the Soft category estimator 302 may preprocess data (e.g. handling missing data). Data Label 304 is also loaded into the memory. Labelled training dataset D (training input data and corresponding labels) is prepared.

The lambda initializer 307 (the User inputs 306) initializes hyper parameters lambda1 3071, lambda2 3072, lambda3 3073 (S302).

Training module 300 executes training with lambda1 3071, lambda2 3072, lambda3 3073. and Labelled training dataset D (obtained by performing S302 and S301 respectively).

In step S304, the Parameters modifier 305 exports the soft-rectangle parameters c₃₀₂, w₃₀₂, s₃₀₂ obtained after executing the training module 300 to the Storage 315.

### <Operation of Model Testing Module 400>

In step S401, the Data input 401 consisting of data points with unknown labels, are loaded into the memory and pre-processed like in the preprocessing step in S301. In step S402, the Testing module 400 loads the rules (soft-rectangle parameters) stored in the Storage 315 into the memory. In step S403, Testing module 400 predicts the category of test input data with soft-rectangle parameters c₃₀₂, w₃₀₂ (obtained in step S402).

The classifier according to the first embodiment can obtain optimal margin rectangle, using a self-learnable parameter s. Also, the classifier can appropriately estimate a category for input data.

### Third Embodiment

The third embodiment of the present disclosure is an extension of the second embodiment to solve the problem of extracting multiple rectangular patterns to categorize data.

### Explain Need of Present Disclosure

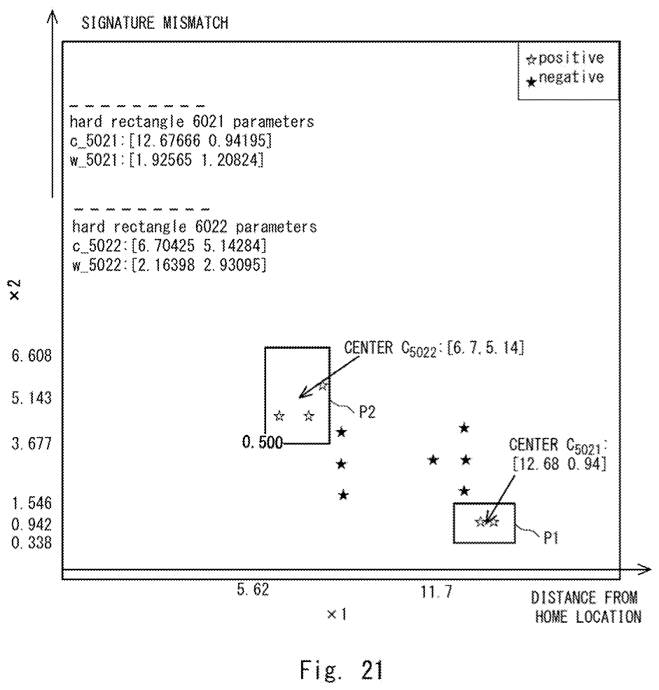

FIG. 21 illustrates a need for extracting multiple rectangular patterns using examples of fraudulent credit card transaction detection using location and signature information. FIG. 21 is a scatter plot of training dataset (includes examples of fraudulent and non-fraudulent transactions). Two patterns/sub-categories of fraud transactions can be clearly seen in FIG. 21. FIG. 21 illustrates the example in which two rectangular patterns are extracted, but not limited thereto. Three or more rectangular patterns may be extracted.

FIG. 21 shows one pattern P1 where the fraud happens far away from the home location (compared to P2), and other pattern P2 where the fraud happens near the home location (compared to P1). Further the P1 has lower signature mismatch and P2 has higher signature mismatch. In other words, the pattern P1 relates to fraudulent transactions which are happening overseas (away from the home location) with good signature forging. The Pattern P2 relates to fraudulent transactions which are happening near home location with bad signature forging.

To summarize, there are two fraudulent patterns P1, P2. First pattern P1 involves fraud happening far away from home location and having a lower signature mismatch. Second pattern P2 involves fraud happening near the home location and having a higher signature mismatch. Any single rectangular pattern covering fraud samples in P1 and P2 will also cover a lot of non-fraud samples, which causes poor classification performance. Thus, in this case, more than one rectangle pattern is necessary to classify data with good classification performance.

In case of multiple rectangle patterns, a test input is categorized as fraudulent if any pattern matches the test input. In other words, the test point is categorized positive if the test point lies inside at least one rectangle.

A test point p103 is matched with all the rectangular patterns. If there are five rectangular patterns, then matching process generates five predictions, where rth prediction denotes if a test point lies inside rth rectangle (where r is an integer >1). A point is finally predicted positive if any one of the five predictions is positive. Accordingly, the test point p103 is categorized positive if it lies inside at least one rectangle.

FIG. 11 is a block diagram illustrating exemplary functional modules of a classifier according to the third embodiment of the present disclosure. The classifier includes a Training Module 500 and a Testing Module 600. First, we will explain the process of matching the test data with multiple extracted patterns to categorize transactions as fraud/non-fraud implemented by the Testing Module 600. Next, we will explain the process of extracting multiple patterns required during testing with the Training Module 500.

### <Testing Module 600>

The Testing module 600 includes a MR Hard Category Estimator 602. The MR Hard Category Estimator 602 receives data input 601 and learnt patterns from storage 515 to predict the category of the input data. “MR” stands for Multiple Rectangle. The Storage 515 may be inside the training module 500 or the testing module 600, or may be outside the training module 500 or the testing module 600.

The Data Input 601 is the storage for the testing data. The Data Input 601 contains the set of data points whose true label/categories are unknown.

The classifier categorizes data point p102 as positive (fraud) if the data point p102 lies inside any rectangle, in other words, at least one rectangle covers point p102.

The MR Hard Category Estimator 602 conducts the inside (at least one rectangle) or outside (of all rectangles) test. The MR Hard Category Estimator 602 receives data point x⁽¹⁰²⁾ as input and generates corresponding hard label [symbol] ₁₀₂. [symbol] ₁₀₂=1 denotes positive categorization, whereas [symbol] ₁₀₂=0 denotes negative categorization.

The MR Hard Category Estimator 602 with lambda4 5074 rectangular patterns (which was learnt in a training process, as described later) further includes lambda4 5074 Hard Category Estimators and one Hard Max Selector 602S.

Lambda4 5074 number of Hard Category Estimators in the MR Hard Category Estimator 602 indicates the number of Hard Category Estimators, which are indexed from 6021, 6022, 6023, . . . 602r. As shown in FIG. 11, for lambda4 5074=2, MR Hard Category Estimator 602 has two Hard Category Estimators 6021, 6022 and Hard Max Selector 602S.

The Hard Category Estimators 6021, 6022 are similar to the Hard Category Estimator 402 explained in FIG. 3. The Hard Category Estimator 6021 categorizes any points inside the rectangle (with parameters c₅₀₂₁, w₅₀₂₁) as positive and any points outside the rectangle as negative.

The MR Hard Category Estimator 602 first predicts (or estimates) binary label (i.e. data point is positive or negative category) for point p102 from the Hard Category Estimators 6021, 6022. The Hard Max Selector 602S categorizes point p102 as positive if either of the Hard Category Estimators 6021, 6022 predicts/categorizes point p102 as positive.

The predicted binary label may be also referred to as predicted hard category.

The Hard Category Estimators 6021 obtains rectangle information on center and width from parameters c₅₀₂₁, w₅₀₂₁. Hard Category Estimators 6022 obtains rectangle information center and width from parameters c₅₀₂₂, w₅₀₂₂.

The Hard category estimator 6021 estimates the category of the test input data. The Hard category estimator 6021 uses the Data Input 601 and predicts/determines/estimates the hard category of each data point. Function ƒ(·,c₅₀₂₁,w₅₀₂₁)ƒ(·,c₅₀₂₁,w₅₀₂₂) is the implementation of hard category estimator 6021. c₅₀₂₁, w₅₀₂₁ are extracted from storage 515.

$$f ( x ; {c}_{5021} , {w}_{5021} ) = {{\prod }^{m}}_{i = 1} step ( ( {u}_{{5021}_{i}} - {x}_{i} ) ) * step ( ( {x}_{i} - {l}_{{5021}_{i}} ) ) \\ step ( a ) = 1 if a > 0 else 0 \\ Where {u}_{5021} = ( {c}_{5021} + \frac{{w}_{5021}}{2} ) , \\ {l}_{5021} = ( {c}_{5021} - \frac{{w}_{5021}}{2} )$$

Where u₅₀₂₁_{ᵢ}, l₅₀₂₁_{ᵢ}, s₅₀₂₁_{ᵢ} are i^{th} dimension of u₅₀₂₁, l₅₀₂₁. Where x is data point with m features.

The MR Hard Category Estimator 602 is implemented in function ƒ_{MR}(·;c₅₀₂₁, w₅₀₂₁,c₅₀₂₂,w₅₀₂₂)

ƒ_{MR}(p102;c₅₀₂₁,w₅₀₂₁,c₅₀₂₂,w₅₀₂₂)=ₘₐₓ( [symbol] ⁶⁰²¹₁₀₂, [symbol] ⁶⁰²²₁₀₂)

Where [symbol] ⁶⁰²¹₁₀₂ denotes the predicted hard category for point p102 by the Hard Category Estimator 6021, and [symbol] ⁶⁰²²₁₀₂ denotes the predicted hard category for point p102 by the Hard Category Estimator 6022.

[symbol]

⁶⁰²¹₁₀₂ƒ(p102;c₅₀₂₁,w₅₀₂₁); [symbol] ⁶⁰²²₁₀₂=ƒ(p102;c₅₀₂₂,w₅₀₂₂)

[symbol]

⁶⁰²¹₁₀₂=1 denotes point p102 is inside the rectangle described by c₅₀₂₁,w₅₀₂₁

### <Training Module 500>

The Training Module 500 is configured to be similar to the Training Module 300 shown in FIG. 3. The Training Module 500 receives training data along with user parameters lambda to extract rectangular patterns of fraudulent transactions. As shown in FIG. 11, the Training Module 500 includes MR Soft Category Estimator 502, Estimation Evaluator 503, Parameter Modifier 505, and Lambda Initializer 507. “MR” stands for Multiple Rectangle.

Training Module 500 receives Data Input 501 and Data Labels 504 as input to produce rectangular patterns. The produced rectangular patterns are stored in Storage 515. The Training Module 500 also receives user input 506 to initialize lambdas in lambda Initializer 507.

The Data Input 501 is the storage for the training data. The Data Input 501 is configured to be similar to the Data Input 301 shown in FIG. 3.

The Data Labels 504 is the storage for true labels/categories of the training data. The Data Labels 504 contains the true labels/true categories for the training data stored in the Data Input 501. The Data Labels 504 is configured to be similar to the Data Labels 304 in FIG. 3.

The Lambda Initializer 507 receives user input 506 to guide the training module 500 in terms of the number of patterns and size/shape of preferred patterns. Lambda Initializer 507 stores user input 506 in variable lambda1 5071, lambda2 5072, lambda3 5073, lambda4 5074, lambda5 5075, and lambda6 5076.

Lambda1 5071, Lambds2 5072, and Lambda3 5073, which are similar to lambda1 3071, lambda2 3072, lambda3 3073, guides the size, position, and softness of the soft rectangle. Lambda4 5074 is an integer denoting the maximum number of patterns that can be extracted. Overlapping smooth rectangles (soft rectangles) sometimes creates a complex decision boundary to obtain marginally lower correctness loss. In other words, get better classification performance. Lambda5 5075 prevents the overlap among rectangles. Lambda6 5076 forces Smooth Max Selector 502S to behave similarly to the Hard Max Selector 602S as described above. Lambda6 5076 and lambda5 5075 prevent formation of decision boundaries not interpretable as being a mixture of rectangles. Lambda4 5074, lambda5 5075, lambda6 5076 may be also referred to as lambda4, lambda5, lambda6.

The MR Soft Category Estimator 502 is configured to behave similarly to the Soft Category Estimator 302. Specifically, the MR Soft Category Estimator 502 receives data point x⁽¹⁰²⁾ as input and generates corresponding soft label ŷ₁₀₂ (fraud/non-fraud).

Soft label ŷ₁₀₂ for data point x⁽¹⁰²⁾ is a number between [0,1] indicating the probability of true label=1 for data point y₁₀₂. For example, estimated soft label ŷ₁₀₂=0.9 means 90% chance x⁽¹⁰²⁾ is positive (label is 1), and 10% chance x⁽¹⁰²⁾ is negative (label is 0).

The MR Soft Category Estimator 502 should have high confidence and correctness about an estimated category. More precisely, the MR Soft Category Estimator 502 should generate a soft label [symbol] for point x^{(j)} close to 1.0 (^{≈}100% chance that category is positive) if true label yⱼ=1. Similarly, the MR Soft Category Estimator 502 should predict a soft label [symbol] close to 0 (i.e. ^{≈}0% chance that category is positive) if true label yⱼ=0.

The MR Soft Category Estimator 502 is configured to learn lambda4 5074 number of rectangular patterns. The MR Soft Category Estimator 502 includes lambda4 5074 Soft Category Estimators and one Smooth Max Selector 502S. The lambda4 5074 Hard Category Estimators in the MR Soft Category Estimator 502 indicate the number of Hard Category Estimators, which are indexed from 5021, 5022, 5023, . . . 502n.

As shown in FIG. 11, for lambda4 5074=2, the MR Soft Category Estimator 502 has two Soft Category Estimators 5021, 5022 and a Smooth Max Selector 502S.

The Soft Category Estimators 5021, 5022 are similar to the Soft Category Estimator 302 explained above. The Soft Category Estimator 5021 generates soft label ŷ₁₀₂⁵⁰²¹ for x⁽¹⁰²⁾ using parameters c₅₀₂₁,w₅₀₂₁,s₅₀₂₁. Similarly, the Soft Category Estimator 5022 generates soft label ŷ₁₀₂⁵⁰²² for the same point x⁽¹⁰²⁾ using parameters c₅₀₂₂,w₅₀₂₂,s₅₀₂₂.

The MR Soft Category Estimator 502, in order to predict final soft label 9102 for point x¹⁰², first obtains soft category estimates ŷ₁₀₂⁵⁰²¹, ŷ₁₀₂⁵⁰²² for point x¹⁰² from the Soft Category Estimators 5021, 5022. Second, the MR Soft Category Estimator 502 receives a smooth maximum on soft category estimates ŷ₁₀₂⁵⁰²¹, ŷ₁₀₂⁵⁰²² from individual rectangles using Smooth Max Selector 502S. The Smooth Max Selector 502S is a differentiable approximation of the Hard Max Selector 602S.

The MR Soft Category Estimator 502 is a differentiable approximation of the MR Hard Category Estimator 602, where the Hard Category Estimators 6021, 6022 are replaced by the Smooth Category Estimators 5021, 5022 and Hard Max Selector 602S is replaced by the Smooth Max Selector 502S.

The Soft Category Estimator 5021 estimates the category of the train input data. The Soft Category Estimator 5021 uses the Data Input 501 and predicts/determines/estimates the soft category of each data point. Function g(·,c₅₀₂₁,w₅₀₂₁,s₅₀₂₁) is the implementation of the Soft Category Estimator 5021.

$$g ( x , {c}_{5021} , {w}_{5021} , {s}_{5021} ) = {{\prod }^{m}}_{i = 1} σ ( {s}_{{5021}_{i}} ( {u}_{{5021}_{i}} - {x}_{i} ) ) * σ ( {s}_{{5021}_{1}} ( {x}_{i} - {l}_{{5021}_{i}} ) ) \\ sigma ( a ) = 1 if a > 0 else 0 \\ Where {u}_{5021} = ( {c}_{5021} + \frac{{w}_{5021}}{2} ) , \\ {l}_{5021} = ( {c}_{5021} - \frac{{w}_{5021}}{2} )$$

Where u₅₀₂₁_{ᵢ}, l₅₀₂₁_{ᵢ}, s₅₀₂₁_{ᵢ} are i^{th} dimension of u₅₀₂₁, l₅₀₂₁, s₅₀₂₁. Where x is data point with m features.

The MR Soft Category Estimator 502 is implemented in function g_MR(·;c₅₀₂₁,w₅₀₂₁,s₅₀₂₁,c₅₀₂₂,w₅₀₂₂,s₅₀₂₂, alpha).

g_{MR(·;c}_{₅₀₂₁}_{,w}_{₅₀₂₁}_{,s}_{₅₀₂₁}_{,c}_{₅₀₂₂}_{,w}_{₅₀₂₂}_{,s}_{₅₀₂₂}_{,alpha)}=smoothmaxₐ(g(x₁c₅₀₂₁,w₅₀₂₁,s₅₀₂₁),g(xᵢc₅₀₂₂,w₅₀₂₂,s₅₀₂₂))

The MR Soft Category Estimator 502 is a differentiable approximation of the MR Hard Category Estimator 602, where the Hard Max Selector 602S is replaced by the smooth maximum 502S and the Hard Category Estimators 6021, 6022 by the Soft Category Estimators 5021, 5022.

The Soft Category Estimator 502 includes soft rectangle parameters c₅₀₂₁,w₅₀₂₁,s₅₀₂₁,c₅₀₂₂,w₅₀₂₂,s₅₀₂₂ describing the position, size and margin width of the two rectangular patterns. The Soft Category Estimator 502 may include alpha which is parameter for controlling the behavior of Smooth Max Selector 502S.

We will now discuss finding values of c₅₀₂₁,w₅₀₂₁,s₅₀₂₁,c₅₀₂₂,w₅₀₂₂,s₅₀₂₂ and alpha so that the MR Soft Category Estimator 502 produces highly confident and correct category estimates (on a training dataset).

The Estimation Evaluator 503 compares the estimated soft labels with the true labels and then outputs a real number which gives feedback on chosen values of c₅₀₂₁,w₅₀₂₁,s₅₀₂₁,c₅₀₂₂,w₅₀₂₂,s₅₀₂₂ and alpha.

The correctness loss 512 is mathematical implementation of Estimation Evaluator. Higher value of correctness loss 512 (or any other classification loss) on labelled training data (train input data and corresponding labels) means the estimated soft labels {ŷ₁, ŷ₂, . . . , ŷₙ} isn are not similar to true labels {y₁, y₂, . . . , yₙ}. Lower value of correctness loss 512 means the estimated labels and true labels are similar.

$$correctness\_loss 512 = \frac{1}{n} * {\sum }_{j = 1}^{n} \vert {g}_{MB ( {x}^{( j )} , {c}_{5021} , {w}_{5021} , {s}_{5021} , {c}_{5022} , {w}_{5022} , {s}_{5022} , alpha )} - {y}_{j} \vert$$

Where D={(x⁽¹⁾,y₁), . . . , (x⁽ⁿ⁾,yₙ)} is the training dataset with n data points. Data feature of i^{th} sample point denoted by x⁽ⁱ⁾ is obtained from Data Input 501. yᵢ is the corresponding label of x⁽ⁱ⁾. yᵢ is collected from the Data labels 504.

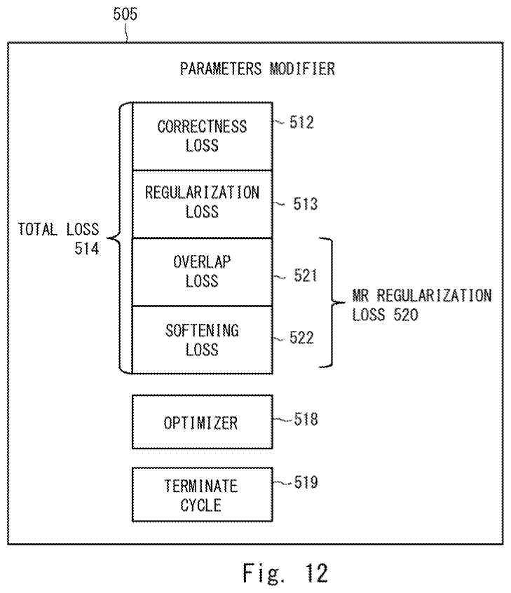

The parameter modifier 505 includes three components: total loss 514, optimizer 518, and terminate cycle 519, as shown in FIG. 12.

1) The Loss function total loss 514 judges the quality of predictions and model structure.
2) The Optimizer 518 modifies the soft-rectangle parameters c₅₀₂₁,w₅₀₂₁,s₅₀₂₁,c₅₀₂₂,w₅₀₂₂,s₅₀₂₂ to reduce the loss function total loss 514.
3) The Terminate cycle 519 saves/updates the learnt pattern to storage 515 and terminates the training module if better values of c₅₀₂₁,w₅₀₂₁,s₅₀₂₁,c₅₀₂₂,w₅₀₂₂,s₅₀₂₂ cannot be found.

We will select the rectangles that keep positive points in the core. This priority over a rectangle is implemented with Regularization Loss 513 in Total loss 514.

The Regularization Loss 513 (any convex regularizer) takes rectangle parameters c,w,s as input and outputs a real number. Lower value of the Regularization Loss 513 means each individual rectangle is wide margined, small in size and closer to the origin.

regularization_loss513=lambda1*∥c₅₀₂₁∥²+lambda2*∥w₅₀₂₁∥²+lambda3*∥s₅₀₂₁∥²+lambda1*∥c₅₀₂₂∥²+lambda2*∥w₅₀₂₂∥+lambda3*∥s₅₀₂₂∥²lambda1,lambda2,lambda3 refers to lambda1 5071,lambda2 5072,lambda3 5073.

In the above section we discussed regularizing individual rectangles in mixture rectangles. Now we will discuss regularizing a mixture rectangle as whole.

A minimum number of non-overlapping individual wide-margined rectangular patterns are preferred by a human in a mixture for better interpretability. Further rectangles should be non-overlapping. This priority given to non-overlapping and minimum rectangle patterns is implemented by MR Regularization Loss 520 in Total Loss 514.

The MR Regularization Loss 520 includes two components overlap loss 521 and softening loss 522 as shown in FIG. 12.

The MR Regularization Loss 520=the softening loss 522+the overlap loss 521

The Soft Category Estimator 5021 predicts label/category 1 (positive) for point p103 if point p103 lies inside the rectangle with parameters c₅₀₂₁,w₅₀₂₁,s₅₀₂₁.

Similarly, the Soft Category Estimator 5022 predicts label/category 1 (positive) for point p102 if point p102 lies inside the rectangle with parameters c₅₀₂₁,w₅₀₂₁,s₅₀₂₁. If two or more rectangles (Soft Category Estimators) predict a positive category for a point p102, then the two or more rectangles overlap. At most one rectangle (or only one rectangle) should predict a positive category for data point p102 to prevent such an overlap situation.

The classifier according to the third embodiment prevents an overlap situation by forcing one (or more) of the overlapped rectangles to stop covering point p102. In other words, the classifier forces the above constraint by ensuring that second maximum of ŷⱼ⁵⁰²¹,ŷⱼ⁵⁰²² is close to 0. A first maximum of ŷⱼ⁵⁰²¹,ŷⱼ⁵⁰²² can be close to 0 or 1 based on ground truth label of a dataset, but a second maximum should always be close to zero.

overlap loss521=lambda5*Σⱼ₌₀ⁿ max(ŷⱼ⁵⁰²¹,ŷⱼ⁵⁰²²)*(1−second_max(ŷⱼ⁵⁰²¹,ŷⱼ⁵⁰²²))

overlap loss 521 is extended to one or more rectangles by rewriting the equation below.

overlap loss521=Σⱼ₌₀ⁿ max(ŷⱼ⁵⁰²¹,ŷⱼ⁵⁰²²,ŷⱼ⁵⁰²²,ŷⱼ⁵⁰²²,ŷⱼ⁵⁰⁰²)*(1−second_max(ŷⱼ⁵⁰²¹,ŷⱼ⁵⁰²²,ŷⱼ⁵⁰²²,ŷⱼ⁵⁰²²))

For lower values of alpha, the Smooth Max Selector 502S performs simple averaging of soft category estimates. For higher values of alpha, the Smooth Max Selector 502S functions like the Hard Max Selector 602S.

To mathematically analyze the behavior of the Smooth Max Selector 502S with different alpha, where ŷ₁₀₂⁵⁰²¹, ŷ₁₀₂⁵⁰²²=0.9 and 0.1 respectively.

| alpha | Smooth Max Selector 502S calculation | [symbol] |
|---|---|---|
| 0 | 0.5 * ŷ₁₀₂⁵⁰²¹ + 0.5 * ŷ₁₀₂⁵⁰²² | =0.5 |
| 1 | 0.68 * ŷ₁₀₂⁵⁰²¹ + 0.32 * ŷ₁₀₂⁵⁰²² | =0.651 |
| 5 | 0.98 * ŷ₁₀₂⁵⁰²¹ + 0.02 * ŷ₁₀₂⁵⁰²² | =0.884 |
| ∞ | 1.0 * ŷ₁₀₂⁵⁰²¹ + 0.0 * ŷ₁₀₂⁵⁰²² | =0.9 |

1. For alpha=0; Smooth Max Selector 502S takes simple average of soft category estimates
2. For alpha=∞; Smooth Max Selector 502S takes max of ŷ₁₀₂⁵⁰²¹, ŷ₁₀₂⁵⁰²².
3. For alpha between 0 and CE; Smooth Max Selector 502S behaves somewhat between simple average and (hard)max (final prediction is between 0.5 and 0.9). In other words, Smooth Max Selector 502S output is higher in comparison to simple average but lower than (hard)max for any input.

The Smooth Max Selector 502S is configured to perform weighted averaging of soft category estimates. The weights depend on alpha. At alpha=0, all the soft category estimate is equally weighted (simple averaging); at alpha >0 the weights to each of the soft category estimates is calculated based on its value, highest value is assigned high weight but all others are also assigned some small weights; and at alpha=inf or very high, maximum soft category estimate gets weight 1 and all others gets 0 weight. The above Table shows calculation of weights at different alpha levels.

The Soft Category Estimator 502 with higher value of alpha best approximates the Hard Category estimator 602. Softening loss 522 ensures that the MR Soft Category Estimator 502 sufficiently approximates the MR Hard Category Estimator 602 by forcing alpha to take a higher value. One example of the Softening loss 522 is given below.

The Softening loss522=lambda6*∥1/alpha∥²

Total loss 514 is a sum of the correctness loss 512, the regularization Loss 513 and MR regularization loss 520, as shown in FIG. 12. The Total loss 514 creates non-overlapping rectangles with small size and softer boundaries, but at the same time correctness loss 512 gets the estimated soft labels to be close to either 0 or 1, which happens only
1. when points lie in the extreme interior or the extreme exterior
2. alpha in the Smooth Max Selector 502S is high.

Thus, the total loss 514 is a minimum when smooth rectangles (soft rectangles) are non-overlapping and also optimal-margined (wide enough so that positive points are in the core and not too wide so that negative points come close to the rectangle boundary).

The Optimizer 518 determines the reason why there is an incorrect estimation and tunes the soft rectangle parameters so that the Soft Category Estimator 502 with updated soft rectangle parameters in Soft Category Estimators 5021, 5022 has a lower total loss 514, in comparison to some predetermined parameter setting. The Optimizer 518 is configured to be similar to the Optimizer 318.

The Optimizer 518 in the parameter modifier 505 is implemented using off the shelf gradient or a line search-based algorithm (such as Adam, SGD, Wofle, Armijio, etc.) to obtain parameter settings to minimize any differentiable function.

Here the Parameters Modifier 505 minimizes the total loss 514 which is rewritten mathematically as Lₘᵣ(c₅₀₂₁,w₅₀₂₁,s₅₀₂₁,c₅₀₂₂,w₅₀₂₂,alpha;D).

$${L}_{m r} ( {c}_{5021} , {w}_{5021} , {s}_{5021} , {c}_{5022} , {w}_{5022} , {s}_{5022} , alpha ; D ) = \frac{1}{n} * {\sum }_{j = 1}^{n} \vert {g}_{mr} ( {x}^{( j )} , {c}_{5021} , {w}_{5021} , {s}_{5021} , {c}_{5022} , {w}_{5022} , {s}_{5022} , alpha ) - {y}_{j} \vert + lambda 1 * {‖ {c}_{5021} ‖}^{2} + lambda 2 * {‖ {w}_{5021} ‖}^{2} + lambda 3 * {‖ {s}_{5021} ‖}^{2} + lambda 1 * {‖ {c}_{5022} ‖}^{2} + lambda 2 * {‖ {w}_{5022} ‖}^{2} + lambda 3 * {‖ {s}_{5022} ‖}^{2} + lambda 5 * {\sum }_{j = 0}^{n} max ( {\hat{y}}_{j}^{5021} , {\hat{y}}_{j}^{5022} ) * ( 1 - second\_max ( {\hat{y}}_{j}^{5021} , {\hat{y}}_{j}^{5022} ) ) + lambda 6 * {‖ 1 / alpha ‖}^{2}$$

Lambda1, lambda2, . . . , lambda6 refers to Lambda1 5071, lambda2 5072, . . . , lambda6 5076.

The Optimizer 518 finds the value c₅₀₂₁,w₅₀₂₁,s₅₀₂₁,c₅₀₂₂,w₅₀₂₂,s₅₀₂₂,alpha using gradient descent so that the L(c₅₀₂₁,w₅₀₂₁,s₅₀₂₁,c₅₀₂₂,w₅₀₂₂,s₅₀₂₂,alpha;D) is minimized.

s₅₀₂₁,s₅₀₂₂ by default takes lower values (in order to lower the Regularization Loss 513), however s₅₀₂₁,s₅₀₂₂ will take large values (i.e., make a margin narrow) if the correctness loss 312 is increased because of the wide margin problem as mentioned above. Thus, the parameter modifier 518 according to the present embodiment has a loss function that selects a rectangle with an optimal margin by determining self learnt parameter s₅₀₂₁,s₅₀₂₂.

The Terminate Cycle 519 stops the iterative process of re-tuning the parameter. The Terminate Cycle 519 decides to stop the training procedure based on some criteria. Examples of the criteria include the case where there is no possibility to tune the parameter anymore (when minimal is achieved) or the case where the maximum number of updates is reached or time is limited. Terminate Cycle 519 terminates the iterative process of re-tuning the parameter. After termination, the Parameters modifier 505 exports the soft-rectangle parameters c₅₀₂₁,w₅₀₂₁,s₅₀₂₁,c₅₀₂₂,w₅₀₂₂,s₅₀₂₂ to the Storage 515. Terminate Cycle also may be referred to as a terminator.

The gradient descent based optimizer 518 continuously makes minor updates to c₅₀₂₁,w₅₀₂₁,s₅₀₂₁,c₅₀₂₂,w₅₀₂₂,s₅₀₂₂,alpha in order to decrease the total loss 514. A termination condition (e.g., maximum number of updates may guarantee Training Module 500) will stop.

### Operations for Third Embodiment

### <Operations for Training Module 500>

alpha should be initialized with a lower value, where gradients for all the rectangles are high, and thus local optima can be avoided, but the training progress alpha takes higher values to make soft labels close to zero or one. However, if alpha does not take a desired value, it will be forced to take higher values by regularizing the softening loss 522. c₅₀₂₁,w₅₀₂₁,s₅₀₂₁,c₅₀₂₂,w₅₀₂₂,s₅₀₂₂, should be initialized with lower values as well.

Flowcharts for the second embodiment are similar to those of the first embodiment (see FIGS. 6 and 7).

The classifier according to the first embodiment can obtain one or more optimal margin rectangle(s), using a self-learnable parameter s. Also, the classifier can appropriately estimate category for input data.

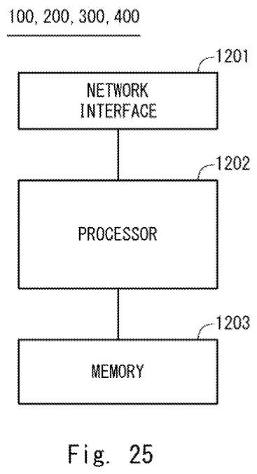

FIG. 25 is a block diagram illustrating a configuration example of the information processing apparatus. In view of FIG. 25, the information processing apparatus (e.g., information processing apparatus 1, module 100, 200, 300, 400, 500, or 600) includes a network interface 1201, a processor 1202 and a memory 1203. The network interface 1201 is used to communicate with a network node. The network interface 1201 may include, for example, a network interface card (NIC) compliant with, for example, IEEE 802.3 series.

The processor 1202 performs processing of the information processing apparatus described with reference to the sequence diagrams and the flowchart in the above embodiments by reading software (computer program) from the memory 1203 and executing the software. The processor 1202 may be, for example, a microprocessor, an MPU or a CPU. The processor 1202 may include a plurality of processors.

The processor 1202 may include a plurality of processors. For example, the processor 1004 may include a modem processor (e.g., DSP) which performs the digital baseband signal processing, a processor (e.g. DSP) which performs the signal processing of the GTP-UUDP/IP layer in the X2-U interface and the S1-U interface, and a protocol stack processor (e.g., a CPU or an MPU) which performs the control plane processing.

The memory 1203 is configured by a combination of a volatile memory and a non-volatile memory. The memory 1203 may include a storage disposed apart from the processor 1202. In this case, the processor 1202 may access the memory 1203 via an unillustrated I/O interface.

In the example in FIG. 25, the memory 1203 is used to store a software module group. The processor 1202 can perform processing of the information processing apparatus described in the above embodiments by reading these software module groups from the memory 1203 and executing the software module groups.

In the aforementioned embodiments, the program(s) can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magneto optical disks), Compact Disc Read Only Memory (CD-ROM), CD-R, CD-R/W, and semiconductor memories (such as mask ROM, Programmable ROM (PROM), Erasable PROM (EPROM), flash ROM, Random Access Memory (RAM), etc.). The program(s) may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

While the present disclosure has been described above with reference to the embodiments, the present disclosure is not limited to the aforementioned description. Various changes that may be understood by one skilled in the art may be made on the configuration and the details of the present disclosure within the scope of the present disclosure.

Part of or all the foregoing embodiments can be described as in the following appendixes, but the present invention is not limited thereto.

### (Supplementary Note 1)

An information processing apparatus, comprising:

a Soft Category Estimator configured to receive a plurality of Data Inputs which includes positive data and negative data and to estimate a soft category using predetermined parameters of a position, size and margin width of a rectangular pattern for classifying the Data Input as the positive data and the negative data;

an Estimation Evaluator configured to compare the estimated soft category label with the true Data labels for the Data Input and output a feedback on the predetermined parameters; and

a Parameter Modifier configured to modify the predetermined parameters to reduce a total loss to learn an optimal margined rectangular pattern for classifying the positive data and the negative data.

### (Supplementary Note 2)

The information processing apparatus according to note 1, wherein the Estimation Evaluator is configured to penalize the rectangle pattern if the rectangle pattern covers the negative point.

### (Supplementary Note 3)

The information processing apparatus according to note 1 or 2, wherein the total loss is a sum of a correctness loss and a regularization loss.

### (Supplementary Note 4)

The information processing apparatus according to any one of notes 1 to 3, wherein the Parameter Modifier includes an Optimizer which is implemented using an off the shelf gradient or a line search-based algorithm.

### (Supplementary Note 5)

The information processing apparatus according to any one of notes 1 to 4, wherein the Parameter Modifier includes a terminator configured to terminate a training process for modifying the predetermined parameters and to save the modified parameters in a storage if a predetermined condition is met.

### (Supplementary Note 6)

The information processing apparatus according to note 1, further comprising:

a Multiple Rectangle (MR) Soft Category Estimator configured to receive the Data Input and estimate a soft category using multiple rectangular patterns, the MR Soft Category Estimator including multiple Soft Category Estimators and a Smooth Max Selector configured to perform weighted averaging of soft category estimates;

a Parameter Modifier configured to modify the predetermined parameters to reduce a total loss to learn optimal margined non-overlapping rectangular patterns for classifying the Data Input as the positive data and the negative data.

### (Supplementary Note 7)

The information processing apparatus according to note 6, wherein the total loss is a sum of a correctness loss, a regularization loss, and a Multiple Rectangle (MR) regularization loss configured to generate non-overlapping rectangular pattern.

### (Supplementary Note 8)

The information processing apparatus according to note 7, wherein the MR regularization loss includes an overlap loss and a softening loss.

### (Supplementary Note 9)

The information processing apparatus according to any one of notes 1 to 8, wherein the Optimizer is configured to determine the predetermined parameters to ensure that the total loss is a minimum.

### (Supplementary Note 10)

A classifier comprising a hard category estimator configured to receive input data and estimate a category of the data point using a model leant by the information processing apparatus according to any one of notes 1 to 9.

### (Supplementary Note 11)

An information processing method, comprising:

receiving a plurality of Data Inputs which includes positive data and negative data and estimating a soft category using predetermined parameters of a position, size and margin width of a rectangular pattern for classifying the Data Input as the positive data and the negative data;

comparing the estimated soft category label with the true Data labels for the Data Input and outputting a feedback on the predetermined parameters; and

modifying the predetermined parameters to reduce a total loss to learn an optimal margined rectangular pattern for classifying the positive data and the negative data.

### (Supplementary Note 12)

A non-transitory computer readable medium storing a program for causing a computer to execute an information processing method, comprising:

receiving a plurality of Data Inputs which includes positive data and negative data and estimating a soft category using predetermined parameters of a position, size and margin width of a rectangular pattern for classifying the Data Input as the positive data and the negative data;

comparing the estimated soft category label with the true Data labels for the Data Input and outputting a feedback on the predetermined parameters; and

modifying the predetermined parameters to reduce a total loss to learn an optimal margined rectangular pattern for classifying the positive data and the negative data.

### INDUSTRIAL APPLICABILITY

The present disclosure can be used as a training device for classifying data using an interpretable discriminator/classifier. Also, the present disclosure can be used as a classifier.

### REFERENCE SIGNS LIST

1 INFORMATION PROCESSING APPARATUS
12 SOFT CATEGORY ESTIMATOR
13 ESTIMATION EVALUATOR
15 PARAMETER MODIFIER
300 TRAINING MODULE
301 DATA INPUT
302 SOFT CATEGORY ESTIMATOR
303 ESTIMATION EVALUATOR
304 DATA LABELS
305 PARAMETER MODIFIER
307 LAMBDA INITIALZIER
312 CORRECTNESS LOSS
313 REGULARIZATION LOSS
314 TOTAL LOSS
318 OPTIMIZER
319 TERMINATE CYCLE
315 STORAGE
400 TESTING MODULE
402 HARD CATEGORY ESTIMATOR
500 TRAINING MODULE
502 MR SOFT CATEGORY ESTIMATOR
5021 SOFT CATEGORY ESTIMATOR
5022 SOFT CATEGORY ESTIMATOR
502S SMOOTH MAX SELECTOR
503 ESTIMATION EVALUATOR
504 DATA LABELS
505 PARAMETER MODIFIER
507 LAMBDA INITIALZIER
512 CORRECTNESS LOSS
513 REGULARIZATION LOSS
514 TOTAL LOSS
515 STORAGE
518 OPTIMIZER
519 TERMINATE CYCLE
520 MR REGULARIZATION LOSS
521 OVERLAP LOSS
522 SOFTENING LOSS
600 TESTING MODULE
602 MR HARD CATEGORY ESTIMATOR
6021 HARD CATEGORY ESTIMATOR
6022 HARD CATEGORY ESTIMATOR
602S HARD MAX SELECTOR

What is claimed is:

1. An information processing apparatus, comprising:
a Soft Category Estimator configured to receive a plurality of Data Inputs which includes positive data and negative data and to estimate a soft category using predetermined parameters of a position, size and margin width of a rectangular pattern for classifying the Data Input as the positive data and the negative data;
an Estimation Evaluator configured to compare the estimated soft category label with the true Data labels for the Data Input and output a feedback on the predetermined parameters; and
a Parameter Modifier configured to modify the predetermined parameters to reduce a total loss to learn an optimal margined rectangular pattern for classifying the positive data and the negative data.

2. The information processing apparatus according to claim 1, wherein the Estimation Evaluator is configured to penalize the rectangle pattern if the rectangle pattern covers the negative point.

3. The information processing apparatus according to claim 1, wherein the total loss is a sum of a correctness loss and a regularization loss.

4. The information processing apparatus according to claim 1, wherein the Parameter Modifier includes an Optimizer which is implemented using an off the shelf gradient or a line search-based algorithm.

5. The information processing apparatus according to claim 1, wherein the Parameter Modifier includes a terminator configured to terminate a training process for modifying the predetermined parameters and to save the modified parameters in a storage if a predetermined condition is met.

6. The information processing apparatus according to claim 1, further comprising:
a Multiple Rectangle (MR) Soft Category Estimator configured to receive the Data Input and estimate a soft category using multiple rectangular patterns, the MR Soft Category Estimator including multiple Soft Category Estimators and a Smooth Max Selector configured to perform weighted averaging of soft category estimates;
a Parameter Modifier configured to modify the predetermined parameters to reduce a total loss to learn optimal margined non-overlapping rectangular patterns for classifying the Data Input as the positive data and the negative data.

7. The information processing apparatus according to claim 6, wherein the total loss is a sum of a correctness loss, a regularization loss, and a Multiple Rectangle (MR) regularization loss configured to generate non-overlapping rectangular pattern.

8. The information processing apparatus according to claim 7, wherein the MR regularization loss includes an overlap loss and a softening loss.

9. The information processing apparatus according to claim 1, wherein the Optimizer is configured to determine the predetermined parameters to ensure that the total loss is a minimum.

10. A classifier comprising a hard category estimator configured to receive input data and estimate a category of the data point using a model leant by the information processing apparatus according to claim 1.

11. An information processing method, comprising:
receiving a plurality of Data Inputs which includes positive data and negative data and estimating a soft category using predetermined parameters of a position, size and margin width of a rectangular pattern for classifying the Data Input as the positive data and the negative data;
comparing the estimated soft category label with the true Data labels for the Data Input and outputting a feedback on the predetermined parameters; and
modifying the predetermined parameters to reduce a total loss to learn an optimal margined rectangular pattern for classifying the positive data and the negative data.

12. A non-transitory computer readable medium storing a program for causing a computer to execute an information processing method, the method comprising:
receiving a plurality of Data Inputs which includes positive data and negative data and estimating a soft category using predetermined parameters of a position, size and margin width of a rectangular pattern for classifying the Data Input as the positive data and the negative data;
comparing the estimated soft category label with the true Data labels for the Data Input and outputting a feedback on the predetermined parameters; and
modifying the predetermined parameters to reduce a total loss to learn an optimal margined rectangular pattern for classifying the positive data and the negative data.
